(19) United States
(12) Patent Application Publication
(10) Pub. No.: US 2004/0145878 A1
(43) Pub. Date: Jul. 29, 2004

(54) USB plug and memory card combination with integrally formed housing

(76) Inventor: Walter Wang, Hsin Tien City (TW)

Correspondence Address: PRO-TECHTOR INTERNATIONAL, 20775 Norada Court, Saratoga, CA, 95070-3018, US

(21) Appl. No.: 10/758,620

(22) Filed: Jan. 14, 2004

(30) Foreign Application Priority Data
Jan. 24, 2003 (TW) 92201418

(51) Int. Cl. H01R 12/16

(52) U.S. Cl. 361/785

(57) ABSTRACT

A USB plug and memory card combination is characterized in an integrally formed metal housing that encloses electrically connected insert of a USB plug and memory card therein, so as to eliminate any stepped neck portion from the metal housing. The metal housing provides good structural strength and has reduced volume adapted to embed in a machine, enabling the USB plug and memory card combination to be widely used as the memory unit of many compact and portable electronic products.

### FIELD OF THE INVENTION

The present invention relates to a Universal Serial Bus (USB) plug and memory card combination with integrally formed housing. The integral housing not only provides the combination with enhanced structural strength, but also makes the combination more practical for use.

### BACKGROUND OF THE INVENTION

There are a variety of memory cards developed for use, such as Compact Flash Card (CF Card), Smart Media Card (SM Card), Multimedia Card (MMC Card), Secure Digital Card (SD Card), and Memory Stick (MS Card). These memory cards have different specifications and therefore could not be used at the same time. Moreover, in using these memory cards, a variety of corresponding card readers are required to connect the memory cards to a personal computer (PC) before data can be read from or written into the memory cards. The conventional memory cards are therefore not convenient for use.

FIGS. 1 and 2 are assembled and exploded perspective views, respectively, of a USB plug 1. As shown, the USB plug 1 includes an insert 11 and a case 12 enclosing the insert 11. There are four terminals 13 mounted on the insert 11 to extend from a top front to a rear end of the insert 11. The USB plug 1 has a standard configuration and has currently been widely used in the connection between computers and peripherals.

In view that the USB plug 1 has been widely and conveniently used in the connection between computers and peripherals, there are manufacturers combining the USB with memory card to develop memory units that may be directly accessed using USB, such as the USB Memory Key developed by IBM, and the Disk on Key developed by MSYSTEM.

FIGS. 3 and 4 are assembled and exploded perspective views, respectively, of a conventional USB plug and memory combination A. As shown, the combination A includes a USB plug 1, a memory card 2, and a plastic memory-card case 3. The memory card 2 consists of a circuit board 21, on which a memory 22 and a control integrated circuit (IC) 23 are mounted. The circuit board 21 is provided near each front corner with an insertion hole 24. The USB plug 1 includes an insert 11, a plurality of terminals 13, and a case 12. The case 12 is formed at two rear corners with two insertion legs 14. The USB plug 1 is electrically connected to the memory card 2 by soldering the terminals 13 to the circuit board 21, and downward inserting the two insertion legs 14 into the two insertion holes 24 near the front corners of the circuit board 21. The connection of the two insertion legs 14 to the two insertion holes 24 enhances a connecting strength between the USB plug 1 and the memory card 2. After the USB plug 1 has been connected to the memory card 2, the plastic memory-card case 3 is used to enclose the whole memory card and a rear portion of the case 12 of the USB plug 1. A front portion of the USB plug 1 is for plugging in a USB socket (not shown) provided on a machine, such as a computer, so as to enable direct access of data on the memory card 2.

The above-structured USB plug and memory card combination A has the following disadvantages in the use thereof:

1. To prevent the two insertion holes 24 on the circuit board 21 of the memory card 2 from collapsing, a predetermined sufficient width “d” must be reserved between each insertion hole 24 and a corresponding lateral edge 25 of the circuit board 21. For this reason, the circuit board 21 has an overall width obviously larger than that of the USB plug 1. Since the plastic memory-card case 3 is designed to enclose the circuit board 21 and a rear portion of the case 12 for the USB plug 1, the case 3 is apparently extended from all four sides of the front portion of the case 12 to have a large volume that causes inconvenience in using the combination A.

2. A stepped neck portion 31 is formed between the front portion of the USB plug case 12 and the expanded plastic memory-card case 3. The expanded case 3 behind the stepped neck portion 31 is projected from the machine, such as the computer, when the USB plug 1 is plugged in the USB socket on the machine. In the event the projected plastic memory-card case 3 is carelessly impacted by an external force, the force would be completely transferred to the neck portion 31, an interior of which is exactly a location at where the terminals 13 on the USB plug 1 are connected to the circuit board 21 of the memory card 2. More particularly, the connected location between the USB plug 1 and the memory card 2 is formed through SMT and very weak as compared with other areas of the combination A. Once the plastic memory-card case 3 is impacted, the connected location of the USB plug and the memory card would be subjected to the impacting force to result in separation of the USB plug from the memory card and accordingly poor contact at the terminals 13 or even a broken circuit board 21 that could not be used any longer.

3. To have increased impact strength, the circuit board 21 of the memory card 2 must have a sufficiently large thickness. Generally, the circuit board is 1.6 mm in thickness. When the two insertion legs 14 are extended through and soldered to the circuit board 21 as reinforcing means, they would inevitably increase an overall thickness and volume of the case 3. Since this type of plastic case 3 has a general wall thickness about 1.5 mm×2, plus the thickness of 1.6 mm of the circuit board, the plastic case 3 has a physical thickness more than 4.6 mm before mounting any other component thereto. When the internal space for the memory and other control components is taken into consideration, the whole case 3 would have an overall thickness more than 10 mm. Therefore, the conventional USB plug and memory card combination A will have a configuration including a small head portion and an expanded body portion to cause inconveniences in carrying it. The combination A having such a configuration simply could not be completely embedded in the machine using it, and could not be used with existing compact and portable electronic products, such as digital cameras, personal digital assistants (PDA), MP3, etc.

### SUMMARY OF THE INVENTION

It is a primary object of the present invention to solve the above-mentioned disadvantages existed in the conventional USB plug and memory card combination A by providing an improved USB plug and memory card combination that has an integrally formed metal housing to completely enclose electrically connected insert of a USB plug and memory card therein, so as to eliminate any stepped neck portion from the metal housing. The metal housing provides good structural strength and has reduced volume adapted to embed in a machine, enabling the USB plug and memory card combination to be widely used as the memory unit of many compact and portable electronic products.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a USB plug;

FIG. 2 is an exploded perspective view of FIG. 1;

FIG. 3 is an assembled perspective view of a conventional USB plug and memory card combination;

FIG. 4 is an exploded perspective view of FIG. 3;

FIG. 5 is an assembled perspective view of a USB plug and memory card combination according to the present invention; and

FIG. 6 is an exploded perspective view of FIG. 5.

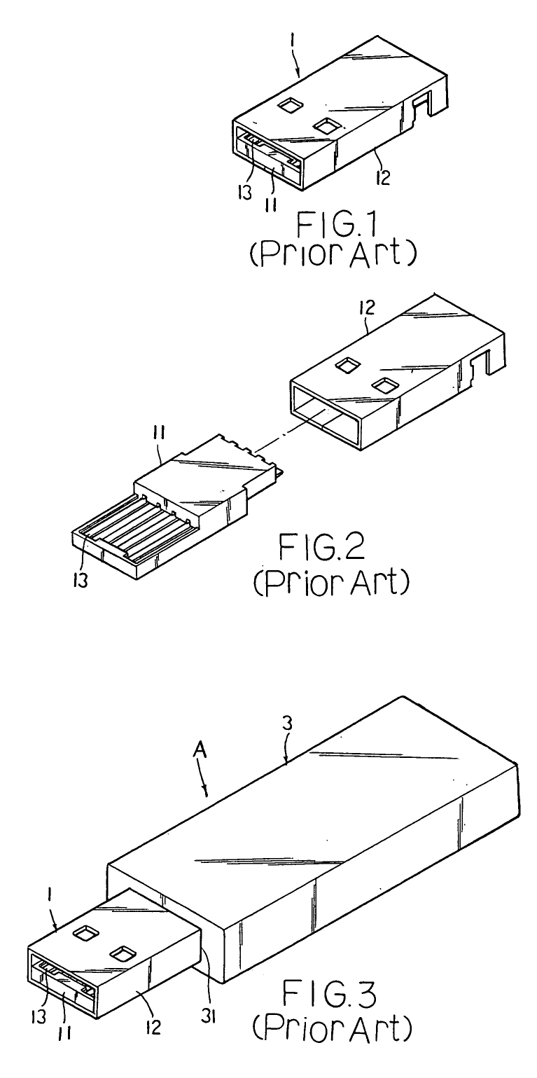

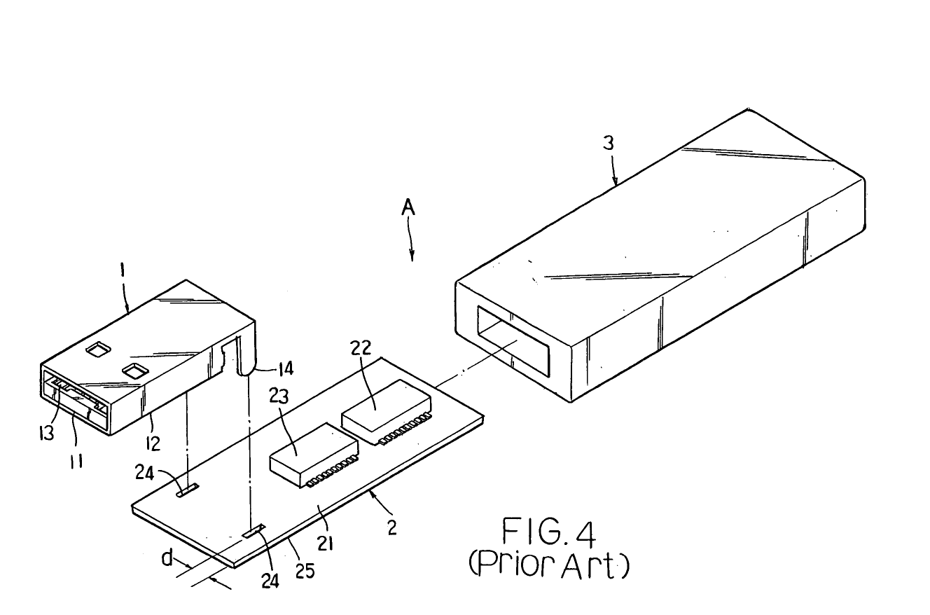

### DETAILED DESCRIPTION OF THE PREFERRED EMBODIMENTS

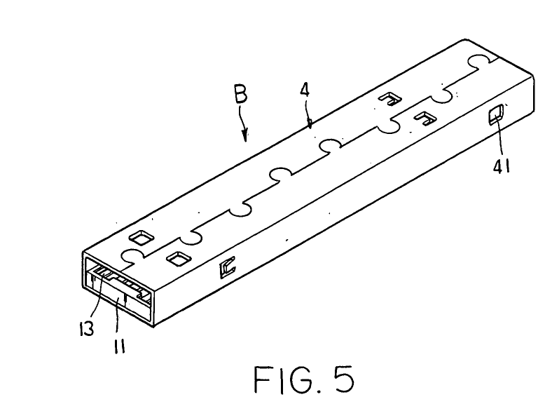

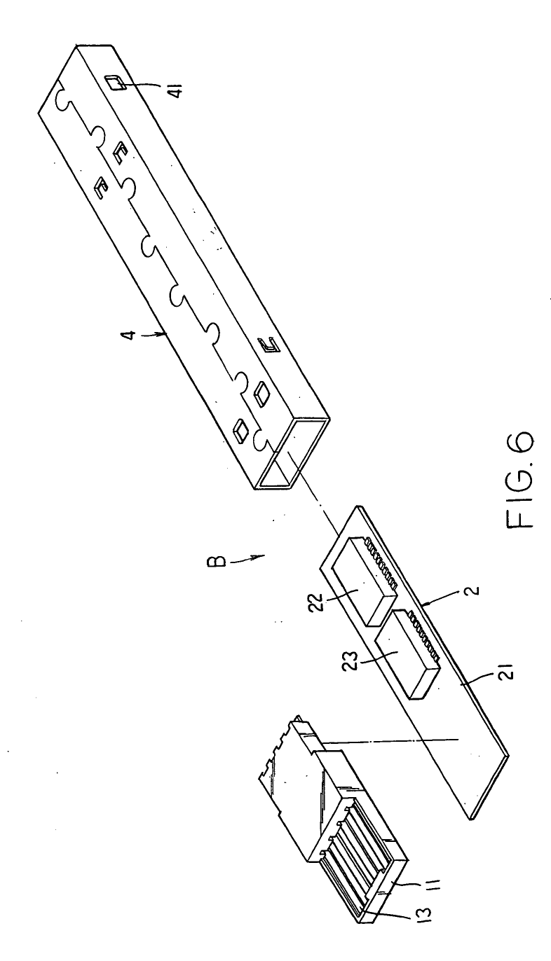

Please refer to FIGS. 5 and 6 that are assembled and exploded perspective views, respectively, of a USB plug and memory card combination B according to the present invention.

As shown, the USB plug and memory card combination B includes an insert of USB plug 11, a memory card 2, and an integrally formed metal housing 4 adapted to enclose the insert of USB plug 11 and the memory card 2 at the same time.

As described above, the memory card 2 includes a circuit board 21, on which at least one memory 22 and a control integrated circuit (IC) 23 are mounted. The insert of USB plug 11 has four terminals 13 mounted thereon to extend from a top front to a rear end of the insert 11. The insert of USB plug 11 and the memory card 2 are electrically connected to each other by soldering the terminals 13 to the circuit board 21 of the memory card 2. The USB plug and memory card combination B is characterized in that the insert of USB plug 11 is not enclosed in a case 12 as the insert 11 of general USB plugs 1. That is, the case 12 is omitted and the insert of USB plug 11 of the present invention is directly soldered to the memory card 2, and an assembly of the insert of USB plug 11 and the memory card 2 is integrally enclosed in the metal housing 4.

The USB plug and memory card combination B of the present invention having an integral housing for the USB plug and the memory card has at least the following advantages:

1. Only one integral metal housing 4 is used to enclose both the memory card 2 and the insert of USB plug 11. Therefore, the USB plug and memory card combination B of the present invention has an overall thickness as small as 4.5 mm, which is a general thickness of a USB plug 1. After deducting from the overall thickness a thickness of 0.6 mm for the upper and lower walls of the metal housing 4, there is still an inner space of 3.9 mm in height in the housing 4 available for use. Thus, as compared with the conventional USB plug and memory card combination A that has an overall thickness more than 10 mm, the present invention is much thinner and smaller, and can be more conveniently carried for use at different places.

2. The metal housing 4 is integrally formed to enclose both the insert of USB plug 11 and the memory card 2 therein, and therefore provides increased structural strength. The weak neck portion 31 on the conventional USB plug and memory card combination A is omitted. In the event the metal housing 4 is impacted by an external force, the force would be evenly distributed over the metal housing 4. The circuit board 21 inside the metal housing 4 does not bear any external force, and would not break at a joint of the insert of USB plug 11 and the circuit board 21. The present invention therefore has upgraded reliability and safety for use.

3. Since the circuit board 21 inside the metal housing 4 does not bear any external force, it may be made of thin board or FPC (flexible printed circuit board) to occupy a minimized space. Therefore, it is possible to accommodate more units of memory 22 in the limited inner space of the metal housing 4 having a height of 3.9 mm only. The thinner circuit board 21 is easier for assembling and reduces an overall weight of the present invention.

4. The metal housing 4 is integrally formed to have straight and smooth outer surfaces. The stepped neck portion 31 on the conventional product is omitted. Therefore, the present invention may be easily and completely located in a machine without exposing any part of the metal housing 4 to external environment. Moreover, the present invention is adapted to use the same USB socket and operating interface (including USB OTG (On The Go) operating interface that enables change of the USB socket from a USB B-B or mini USB to a USB A) on general portable electronic products. Therefore, it is possible for the general portable electronic products to omit the memory card socket and the corresponding operating interface to largely reduce the space needed by the electronic products and the manufacturing cost thereof. The metal housing 4 is in the form of a strip, enabling the present invention to be widely used with many compact and portable electronic products, such as digital camera, personal digital assistant (PDA), MP3, etc. to serve as an expansion memory card. That is, the present invention has largely increased fields of application.

When the present invention is inserted into a machine for use, as mentioned in the above paragraph, the metal housing 4 may be further provided on one side wall at a predetermined position with a card-ejecting notch 41, and the machine is internally provided at a corresponding position with ejecting mechanism (not shown), so that the present invention not in use may be ejected from the machine through operating of the ejecting mechanism.

What is claimed is:

1. A USB plug and memory card combination having an integrally formed housing, comprising:
an insert of USB plug, on which four terminals are mounted to extend from a top front to a rear end of said insert;
a memory card consisting of a circuit board, and a memory and a control IC mounted on said circuit board, said circuit board being electrically connected to rear ends of said four terminals on said insert of USB plug by way of soldering; and
an integrally formed overall metal housing adapted to completely enclose both said insert of USB plug and said memory card therein.

2. The USB plug and memory card combination having an integrally formed housing as claimed in claim 1, wherein said metal housing is provided on a side wall at a predetermined position with a card-ejecting notch.
